(19) United States
(12) Patent Application Publication
(10) Pub. No.: US 2008/0103818 A1
(43) Pub. Date: May 1, 2008

(54) HEALTH-RELATED DATA AUDIT

(75) Inventors: Sean Patrick Nolan, Bellevue, WA (US); Gaurav Dinesh Kalmady, Kirkland,, WA (US); Johnson T. Apacible, Mercer Island, WA (US); Vijay Varadan, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/860,238

(22) Filed: Sep. 24, 2007

Related U.S. Application Data
(60) Provisional application No. 60/863,897, filed on Nov. 1, 2006.

(51) Int. Cl. G06Q 50/00

(52) U.S. Cl. 705/2

(57) ABSTRACT

Systems (and corresponding methodologies) that facilitate tracking ‘actions’ associated with records and data maintained within a centralized health-related data repository are provided. Effectively, an audit trail helps the user keep track of all the changes and accesses that happened on the user's record and can help them understand the control offered to them over their personal information by the health-related data system. Thus, trust and confidence can be enhanced due to the personal control a user has with regard to access and tracking of the health record. Additionally, the innovation can apply a schema that corresponds to a particular action prior to generating the audit trail or log.

### CROSS REFERENCE TO RELATED APPLICATIONS

This application claims the benefit of U.S. Provisional Patent Application Ser. No. 60/863,897 filed on Nov. 1, 2006, entitled “INTERACTIVE AND INTUITIVE HEALTH AND FITNESS TRACKING,” and is related to U.S. patent application Ser. No. 11/745,898 filed on May 8, 2007, entitled “HEALTH INTEGRATION PLATFORM SCHEMA” the entireties of which are incorporated herein by reference.

### BACKGROUND

The evolution of computers and networking technologies from high-cost, low performance data processing systems to low cost, high-performance communication, problem solving, and entertainment systems has provided a cost-effective and time saving means to lessen the burden of performing every day tasks such as correspondence, bill paying, shopping, budgeting information and gathering, etc. For example, a computing system interfaced to the Internet, by way of wire or wireless technology, can provide a user with a channel for nearly instantaneous access to a wealth of information from a repository of web sites and servers located around the world. Such a system, as well, allows a user to not only gather information, but also to provide information to disparate sources. As such, online data storing and management has become increasingly popular.

For example, collaborative social networking websites have exploded world-wide. These sites allow users to create remotely stored profiles including personal data such as age, gender, schools attended, graduating class, places of employment, etc. The sites subsequently allow other users to search the foregoing criteria in an attempt to locate other users—be it to find a companion with similar interests or locate a long lost friend from high school. As another more practical example, banking websites offer users the ability to remotely store information concerning bills to be paid. By utilizing this feature, users can automatically schedule bill payments to be made from their bank account which will be automatically debited when the payment is scheduled. This allows simultaneous electronic management of account balancing and bill paying such to save the user from manually entering checks into the register of their checkbook.

Another area of great interest in this country and the entire world is personal health and fitness. Many vastly differing concerns can be discussed in this area, such as setting and obtaining personal fitness goals and the vastly disparate topic of the inefficiencies existing in our health system. For example, today an individual wishing to receive pharmaceutical treatment for illness must first see their primary care physician. Before seeing the physician, the patient will, many times, be required to show their health insurance coverage card. During the visit, the physician will typically write a prescription for the patient. The patient, then, takes the prescription to the pharmacy for fulfillment at which time they may need to furnish their health insurance coverage card again. The pharmacy fills the prescription, notifies insurance, deducts any coverage amount and transfers the prescription to the patient upon payment of the balance. These manual steps are time-consuming, annoying, inefficient, and prone to errors.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises systems (and corresponding methodologies) that facilitate tracking actions associated with records and data maintained within a health-related data repository. This data repository can be a central repository for the health information associated with a user. The user typically has access to one or more records within the system where each record represents a collection of information associated with the particular user.

The information associated with a health record is most often represented as a collection of elements known as ‘things’ (or data elements). A user who has rights to a particular record can, depending on the access rights, add new things, change existing things, read/access things, or delete things from a health record. The user can also, depending on the access rights, grant access rights to all or part of the information in the health record to another user. These examples are representative of the ‘actions’ auditable by the innovation.

Effectively, the audit trail helps the user keep track of all the changes and accesses that happen on the user's record and can help them understand the control offered to them over their personal information by the health-related data system. Accordingly, the audit trail is one aspect of personal control offered to the user. Thus, trust and confidence can be inherently enhanced due to the personal control a user has with regard to access and tracking of the health record.

In other aspects, the innovation can express audit information in a structural manner that applies to a particular action. In other words, the innovation can apply a schema that corresponds to a particular action prior to generating the audit trail or log. The audit information can include most any information (e.g., snapshot) associated with an action including, but not limited to, data element or thing affected, attributes of the record itself changed, time of action, identity of the user that prompted the action, the identity of the application that rendered the action, among others. In the case of an authorization change action, the audit information can include a delta which represents the change in permission/restriction.

In yet another aspect thereof, machine learning and reasoning (MLR) mechanisms are provided that employ probabilistic and/or statistical-based analysis to prognose or infer an action that a user desires to be automatically performed.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example system that facilitates auditing actions associated with records within a health-related data network.

FIG. 2 illustrates an example flow chart of procedures that facilitate generation of an audit log in accordance with an aspect of the innovation.

FIG. 3 illustrates an example audit component that identifies and captures actions in accordance with an aspect of the innovation.

FIG. 4 illustrates an example monitor component that establishes audit information in accordance with an aspect of the innovation.

FIG. 5 illustrates an example capture component that captures audit information in accordance with an aspect of the innovation.

FIG. 6 illustrates an example schema component that facilitates standardized storage of audit information in accordance with an aspect of the innovation.

FIG. 7 illustrates an example schema in accordance with an aspect of the innovation.

FIG. 8 illustrates an example system that facilitates a cache to regulate storage of audit information in accordance with an aspect of the innovation.

FIG. 9 illustrates a block diagram of a computer operable to execute the disclosed architecture.

FIG. 10 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

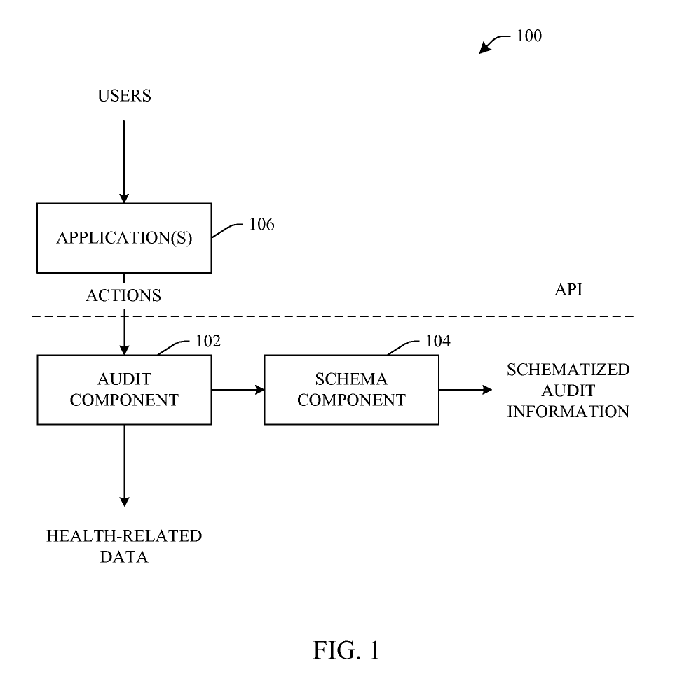

Referring initially to the drawings, FIG. 1 illustrates a system 100 that facilitates auditing changes and accesses related to healthcare information in accordance with an aspect of the innovation. More particularly, the system 100 enables most any access, change, modification, deletion, authorization changes, etc. to data associated with a healthcare data record to be logged or audited. In aspects, this functionality can be employed to increase consumer awareness and confidence with respect to captured health-related data. As well, the functionality of the innovation can grant a user personal control to track changes and/or accesses to their health data.

Effectively, because user can control who can access, or modify healthcare information, the auditing functionality can compliment these safeguards by providing an audit trail in the event a user desires (or needs) to recreate records or trace records. Additionally, the auditing capabilities of the innovation can compliment a user's ability to control which applications can be used to access, modify, create, delete, etc. health-related data. In other words, the audit trail enables a user to track touches to data as well as any modification to the data records. Still further, as will be described in greater detail below, the system 100 can track (or audit) any changes to authorization rules/parameters associated with health-related data.

The innovation, (e.g., system 100) facilitates auditing access and changes related to data within a health integration network. Additionally, the innovation provides for a schema that can be used to maintain audit data. Effectively, the innovation provides for ability to capture and render changes and accesses (and changes to access authorizations) related to health-related data. The innovation includes systems and methods such as, but not limited to a GetRecordsAudit method and GetThings method, in its get version or get older version variant. In other words, it is to be understood that the innovation is capable of accessing and exposing the audit data to a user in most any desired manner.

These functionalities are but example features and/or elements of the infrastructure. In aspects, changes can be tracked with regard to who made the changes, to what data element or record the change was made, the change that was made as well as through what application the change was made. Further, the innovation can monitor and log changes to authorization criteria associated with a data element or record.

While examples are given herein, it is to be understood that the innovation can be applied to most any health-related data without departing from the spirit/scope of the innovation. For instance, data from a heart rate monitor can be captured, schematized and stored as described in the Related Application identified above. This information can be shared with, or accessed from, a trainer application for most any reason including but, not limited to, assessing fitness level/progress based upon heart rate, calculating the amount of exercise an individual completes based upon heart rate, how much weight is lost as a function of heart rate, etc. Accordingly, the innovation can monitor and log changes and accesses to the data.

In another example, health-related data can be used in diabetes management. For instance, a glucometer can inject information into the health-related data system. This information can later be exposed to a disease management tool. Similarly, a third-party provider can manage a patient's condition remotely via this disease management tool. As will be understood, the innovation can be used to track accesses by the third party in connection with the management tool.

In still another aspect, health-related data can be captured as it relates to a discharge record from a hospital or other healthcare facility. For instance, the data can include films, charts, and other data related to the record associated with a patient's visit. Essentially, the health-related data can originate from a variety of sources including, but not limited to, most any medical device such as those having outputs (e.g. blood pressure monitor, weight scale, blood/sugar level monitor, IV, pacemaker, stethoscope, x-ray, etc.), personal fitness tracking devices (combination heart rate monitor watches, pedometers, bicycle equipment (such as speedometers, altimeters, odometers, etc.), stop watches, and the like), and other applications including user interfaces for personal use and medical use. Also, the data can be any data such devices and applications can possibly output including, but not limited to, blood pressure readings, blood/sugar levels, heart rate, body temperature, cholesterol level, images, bicycle/walking speed and distance, fitness routine specifics, diet routine specifics, virtual fitness tracking information, and the like. The data and devices producing the data are virtually limitless.

Accordingly, this data can be accessed, modified and/or changed by a limitless number of devices and/or applications. Hence, there is value in generating an audit trail (tracking log) related to access, manipulation, changes in access rights, etc. It is to be understood that that aforementioned are merely examples and that the system 100 can be extensible such that the scope of the information can grow and thereafter be captured and tracked. Thus, it is to be appreciated that other examples exist and are to be included within the scope of the innovation and claims appended hereto.

By ensuring the audit log data conforms to a schema, subsequent applications can leverage the data since they know how it is stored (or have access to such information via various components or an application program interface (API)). This uniform schematized information enhances usability by consumers such that they can employ a variety of application for access. As mentioned above, ease of access to the audit data will enhance consumer confidence in such a system (e.g., central repository of health-related data).

Referring again to FIG. 1, generally, system 100 can include an audit component 102 that monitors and tracks accesses to health-related data. As described above, accesses, changes, modifications, deletions as well as authorization changes associated to data elements or records within a health-related network can be monitored (e.g., tracked, logged). In accordance therewith, a schema component 104 can be employed to format and effectuate saving the data thereby establishing a standardized audit trail. In aspects, it will be understood that the health-related network can refer to a central repository for the health information associated with a user or patient.

The user typically has access to one or more records in the system. Each record represents the collection of information (e.g., data elements) associated with a particular user. The information associated with a health record is represented as collection of data elements known as ‘things.’ A user who has rights to a particular record can, depending on the access rights, add new things, change existing things or delete things from a health record. The user can also, depending on the access rights, give or grant access rights to all or part of the information in the health record to another user. These represent the ‘actions’ that can be audited by the subject innovation.

The audit trail helps the user keep track of all the changes and accesses that happened with respect to the user's record and helps them understand the control offered to them over their personal information by the system, thus generating trust about the central repository system. Also a part of the issue alleviated by the audits system of the innovation is to represent various kinds of changes that can occur on a record, each change with its own structural representation, so that the disparate structures of these changes can be unified and stored and accessed when needed.

In operation, users (e.g., healthcare professionals) and/or applications 106 can generate an action directed to the health-related data network. The actions can be most any data altering or accessing action including, changes, modifications, revisions, replacements, deletions, creations, etc. Still further, the action can be related to modification of authorization rights associated with a data element, group of data elements and/or records, etc. By way of further example, it is to be understood that an application 106 can include, queries, reports, sensors, assessment programs, disease/condition discovery tools, etc.

Effectively, the innovation describes an architecture (e.g., system 100), the actual APIs and the schemas used to establish and capture an audit trail in the healthcare domain. These APIs are used to communicate with the platform to get audit information regarding access or changes to the health record(s). The schema component 104 is used to store the audit information efficiently so as to ensure that writing to the schema does not compromise the overall performance of the system 100.

It will be understood and appreciated that uniformity of the audit API and schema 104 would allows protection of these investments and allows an offering of something unique in this space in terms of the ability to store and retrieve health and wellness data in a predictable and extensible fashion.

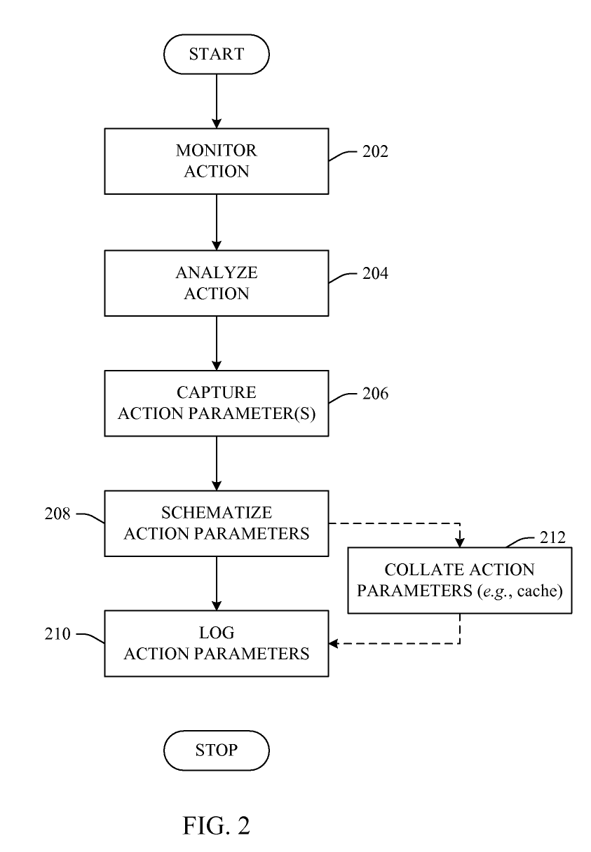

FIG. 2 illustrates an example methodology of establishing an audit trail in accordance with an aspect of the innovation. The example methodology illustrated in FIG. 2 depicts an example flow of acts that facilitate tracking accesses, modifications and authorization changes with respect to a health-related data network. As described above, accesses, modifications, and authorization changes are referred to as ‘actions’ herein.

While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 202, actions can be monitored in order to commence the auditing process. Here, a monitoring component can be employed to identify actions related to the health-related network. The identified actions can be analyzed at 204 in order to define parameters associated with the particular action. For example, parameters can include, but are not limited to, type of action (e.g., change, access, authorization change . . . ), scope of action, identity of user that prompts the action, identity of application used to initiate action, etc.

The identified parameters can be captured at 206. Thereafter, the action together with the parameters can be schematized at 208 and subsequently stored at 210. Here, the audit log can be established (or updated) in order to provide a history or trail that defines specifics associated with actions that correspond to a health-related network. Further, as described above, in this example, the audit log is schematized such that the format can be consistent thereby enabling efficiency and usefulness of the log.

Optionally, as illustrated by the dashed lines, the schematized data can be collated (or cached) at 212 to eliminate or alleviate regular or constant retention. Here, criteria (e.g., rules) can be established that define when action parameters are to be logged. In operation, this can alleviate frequency of writing redundant data to the log.

It is to be appreciated that the example methodology of FIG. 2 highlights key aspects of the record audit innovation. More particularly, the innovation, as illustrated by the example methodology, can discover and maintain information about changes (e.g., create, update, delete) to ‘things.’ Additionally, the innovation can discover and maintain information about general access to ‘things’ as well as most any changes made to the access rights of users to the information stored in a health record.

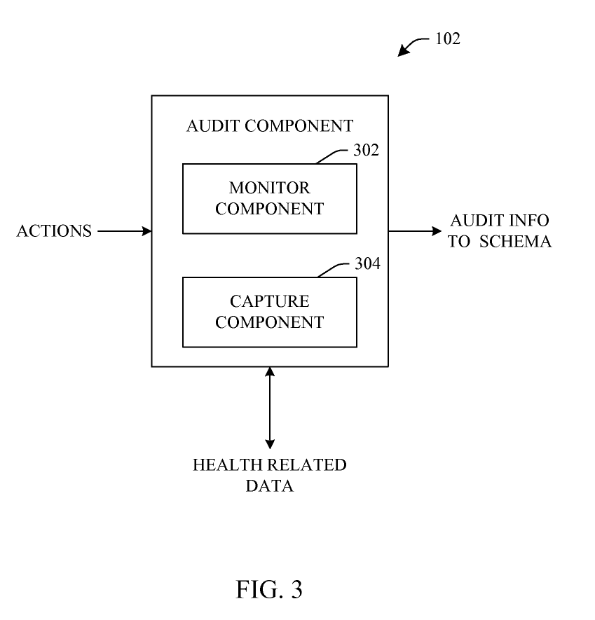

Referring now to FIG. 3, a block diagram of an example audit component 102 is shown in accordance with an aspect of the innovation. Generally, the audit component 102 can include a monitor component 302 and a capture component 304 which together facilitate discovery and identification of actions and associated defining parameters. It is to be understood that most any mechanisms can be employed to establish actions and the associated parameters.

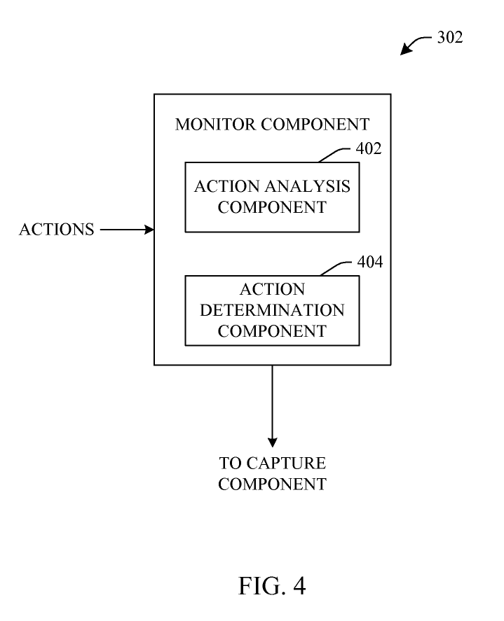

FIG. 4 illustrates, an example block diagram of a monitor component 302 is shown in accordance with an aspect of the innovation. As illustrated, the monitor component 302 can include an action analysis component 402 and an action determination component 404 which establish action parameters and types respectively in accordance with aspects of the innovation. In operation, the action determination component 404 can be employed to establish the type of a given action (e.g., change, access, authorization modification . . . ). Similarly, the action analysis component 402 can be employed to establish parameters associated with a given action or set of actions.

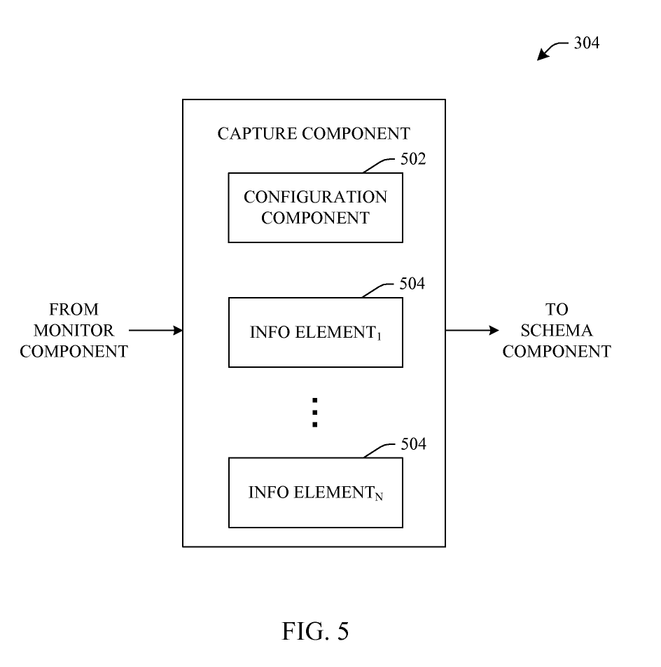

Once analyzed, the information is captured as shown in FIG. 5. Essentially,

FIG. 5 illustrates an example, block diagram of a capture component 304 in accordance with an aspect of the innovation. As described above, the capture component 304 enables information to be staged for retention within an audit log. In one aspect, the capture component 304 can include a configuration component 502 that configures data elements and corresponding parameters 504 for storage/retention in the audit log.

Together, the monitor component 302 and capture component 304 enable identification and preparation of information for retention within an audit log. In aspects, equality of identifiers (e.g., thing id versus version id) is used to identify an action for the audit trail. In other aspects, flagging mechanisms are used to indicate most current versions. In other words, older versions can be shown as snapshots in time or state. It will be appreciated that time/date stamps can be used to identify the versions.

The following example is included to add perspective to the innovation and is not intended to limit the scope of this disclosure in any way. Rather, it is to be understood that most any mechanism of determining actions and identifying actions (and associated parameters) can be employed without departing from the spirit and/or scope of the innovation. The following example employs equality of version stamps against thing identifier (id) in order to identify an action.

In this example, the things are maintained in the health-related data system in a partitioned set of collections each containing things uniquely identified by a GUID (globally unique identifier) identifier, the thing id. An audit trail of the changes, creation, deletion, performed as well as accesses to and authorization modifications performed on things is maintained by retaining time-stamped versions of things in the same collection as the things themselves. It is to be understood that, in aspects, changes to the authorizations to the things in a record and the audit log of accesses to the things themselves are not address by maintaining versions of the things in the store. Rather, these events are captured as audit entries in a records audit store.

Here, the monitor component 302 and capture component 304 facilitate this retention. In this example, each thing version is identified by a unique GUID version stamp. As well, each thing version shares the same thing id as all the other versions of the thing it represents. The current version of a thing has the property that its thing id and version stamp are the same GUID value.

As described above, the aforementioned is but one example of an audit retention mechanism or scheme in accordance with an aspect of the innovation. Similarly, other schemes exist and are to be included within the scope of the innovation and claims appended hereto. For example, a flagging scheme can be employed to identify or mark audit information. In one aspect, a flag is associated with the thing in order to indicate a current version. It is to be understood that these alternative described aspects are to be included within the scope of the innovation and claims appended hereto.

In aspects, useful audit information to be maintained when a thing is created, updated or deleted (or accessed or authorization modification) includes a time stamp representing the action time, the unique identifier of the person who performed the operation, the unique identifier of the impersonator, if impersonation was used to perform the operation, the unique identifier of the application that was used to perform the operation and the access method used to perform the operation. It is to be understood that most any combination of these (or additional) parameters can be employed without departing from the scope of this specification.

Examples of access methods would be the use of online access when a person is signed in to perform the operation. Conversely, another example of an access method is an offline access when the application batches and performs the operation for the person when the person was not signed in. In either case, these scenarios are considered actions upon things which can therefore be audited in accordance with aspects of the innovation.

The following description is provided to add perspective to the innovation. In particular, the discussion that follows is directed to mechanisms involved in establishing an audit log. It is to be understood that this described audit log methodology is not intended to limit the innovation, but rather to set forth but one example of how an audit can be established. Other aspects employ flagging techniques to identify the current version—these flagging techniques are to be considered within the scope of the innovation. Typically, a newly created thing is added as an element to the health-related data system with a freshly generated thing-id and a version-stamp, both of which are equal. Other than the expected data associated with the thing, the aforementioned audit information (e.g., parameters) is added to information that is associated with the thing.

Therefore, upon creation, the thing typically gets a create date and an update date which, when equal, represents the creation of the thing. When any changes such as update or delete are performed to the thing, the original version of the thing in the health-related data system or network is assigned a new version stamp and retains its old thing id. A new version of the thing is then created by the capture component 304 with its thing id and version stamp as equal. This new version retains the created date of the thing it represents. The changes to the information as a part of update or the marking (e.g., flagging) of the thing as deleted are operations performed on the newly created version. Association with the new version is accomplished by a flag or a new set of audit information (e.g., parameters) that represent the time of the operation and the person, impersonator and application involved in performing the action.

A ‘GetThings’ API call (or query) can be used to get the things associated with a health record in the system. This API contains extensions which can be used to request, along with the data, the audit information with the things returned. It also allows the caller to get older non-current versions of the things in the system.

A second part of the audit trail is directed to the structures used to maintain information about access actions to the information in the user's health record. Additionally, structures can be used to track grant, revoke or change actions made to the access rights of different users to a specific health record and/or the information within it.

As described above, a collection of audit information entries is maintained in the health-related data system to represent the operations (e.g., actions). In one aspect, typical operations that a user can perform with respect to a health record would be to create a fresh record, update its name, delete the record, and record access related changes, and also read information present in the record as things. The access to the information in a record is conveyed as a combination of the record, the user or person to whom the access rights are available and the application which the user can use the record per the available access rights.

A typical flow of rights can be described as user A offering the access of a record belonging to user A to another user B to use with the default application. If the user B chooses, he or she could accept the offer and thus get rights to use the record with the default application. The user B can then extend his or her access to the record to other applications in the health-related eco system that can meaningfully operate on the information in the health record, and that the user B is permitted to employ.

All these different actions can be represented in the audit system by means of separate audit action identifiers, flags or the like. However, it is to be understood that these identifiers, flags or the like are optional to the innovation. The audit actions themselves can be used to represent different actions within the audit system.

When a user, e.g., person that uses an application to perform any of the above operations on a health record, initiates an action, an entry is added to the record audits collection which can contain parameters such as the action id representing the action, the audit information set (person, impersonator, application and time) and a free form XML (extensible markup language) that contains representation of the values in the health record that changed as a result of the operation, name value pairs where the name represents the field which changed and the value, the new value that the field received. In accordance with the innovation, when auditing the access of information in a health record, the changes are most often not applicable and hence not logged as a part of the free form XML. The free form XML with the name value pairs for the changes serves to create a generic structure to represent most all kinds of changes that can happen to the record. It is to be understood that the aforementioned is an implementation detail included to add perspective to the innovation. Thus, alternative schema used to store the audit entries are to be included within the scope of the innovation described herein.

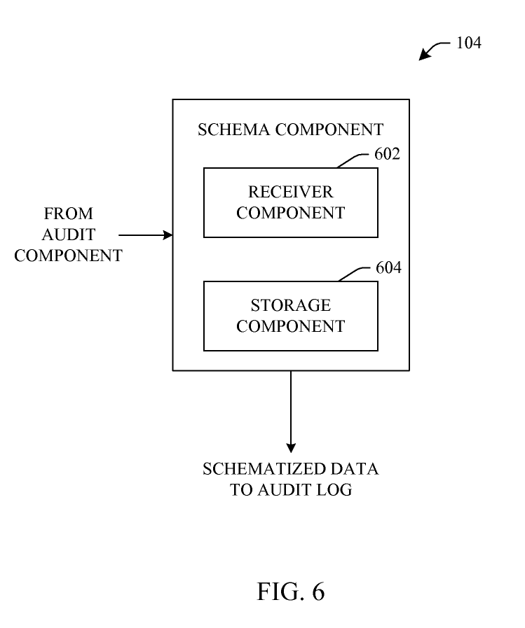

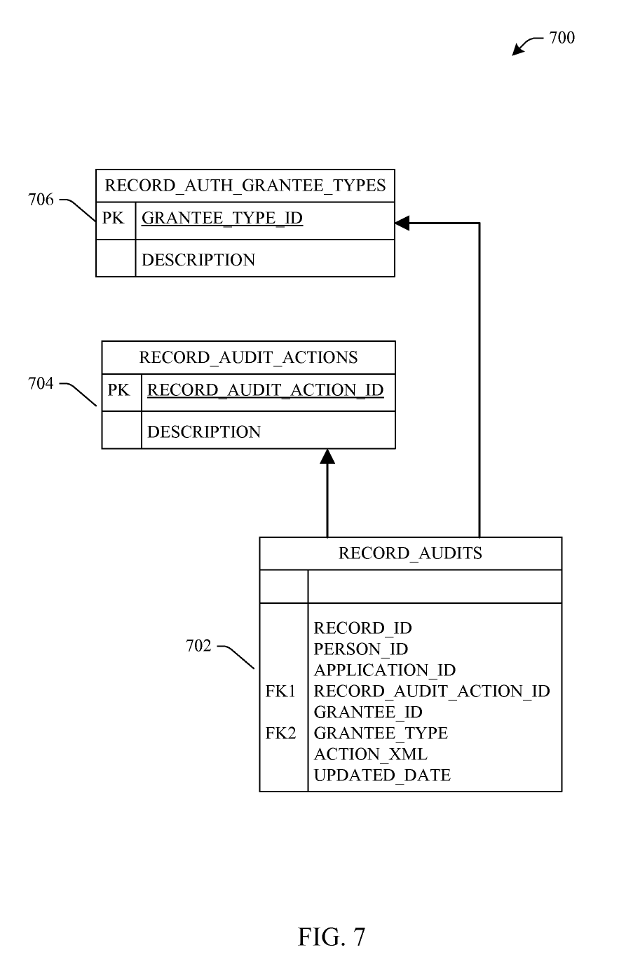

Referring now to FIG. 6, block diagram of an example schema component 104 that facilitates applying a schema to audit information (data and parameters) and storing the audit information is shown. A schema component 104 is provided which comprises a receiver component 602 and a storage component 604. The receiver component 602 receives audit data, which can be provided in many different formats or structures. The storage component 604 receives the data after a schema (FIG. 7) is applied over the data and stores the data in the audit log according to the schema. The schema 700 of FIG. 7 can be independently stored and applied by the schema component 104. Additionally, the schema can be a set of rules utilized by the schema component 104 to make data compliant with storage in the audit log.

The receiver component 602 can receive audit information related to many actions. For example, the data can be the thing, action type, date/time, user identity, application identity, action XML, etc. The receiver component 602 and/or the storage component 604 can apply the schema rules to the audit information and thereafter establish the audit log. Alternatively, another component (not shown) can apply the schema rules. It is to be appreciated that this process, as well as receiving and storing the data, is not limited to being performed by or within the schema component 104. Additionally, the schema component 104 is not limited to operating outside of the health-related data network; rather it can also be integrated within the health-related data network in alternative aspects.

FIG. 7 presents an example schema 700 in accordance with storing audit information related to the subject matter described herein. Respective items identified by reference numerals can be most any type of accessible data structure, hierarchical element, relational database table, and the like. For example, the item can represent a portion of an XML file, a database entity (such as a database, table, field, etc.), or the like. It is to be appreciated that the subject matter is not so limited to the following embodiment; rather this embodiment is used to facilitate further discussion of the subject matter.

Referring to FIG. 7, a schema 700 can be provided to effect storage of data relating to record auditing. The data conforming to this storage schema represents action history of some or all records in a health integration network. A portion of this schema can be provided to store data regarding actions taken on respective records; this item can be a RECORD_AUDITS 702 item having a record_id to identify the record to which the auditing information (e.g., parameters) applies. It is to be appreciated that a single record may have essentially any number of associated audit records (from 0 to N, where N is a positive integer).

The item can also provide for storage of information regarding the person and/or application that changed the record (such as person_id and application_id). An XML representation of the action taken against the record can also be stored along with reversal instructions to provide easy rollback of unwanted changes. Additionally, an identifier relating to the action taken can be provided along with another item that identifies the action codes and description of such to provide a user with an easy understanding of the action taken.

This information can conform to a RECORD_AUDIT_ACTIONS 704 item, which can have possible values of added, deleted, read, written, and the like. Changes to authorization rules can also be tracked, specifically, record level authorization. The RECORDS 702 item can have values corresponding to a grantee_id and a grantee type to identify how a level of authorization changed for a given user (grantee). Additionally, a RECORD_AUTH_GRANTEE_TYPES item 706 can be provided to identify the type of authorization changed and provide a description to what the type indicates.

It is to be understood that the schema can change based upon action or data type. For instance, if the action changes data within a container itself, copies of the data can be made and thereafter versioned (e.g., snapshot). In another example, if the action tracks authorization, here the action can be tracked as a delta or change in authorization rights (e.g., rather than versioning). It is to be understood that the system is extensible and can be applied to most any type of action or audit—these alternative examples are to be included within the scope of the disclosure and claims appended hereto.

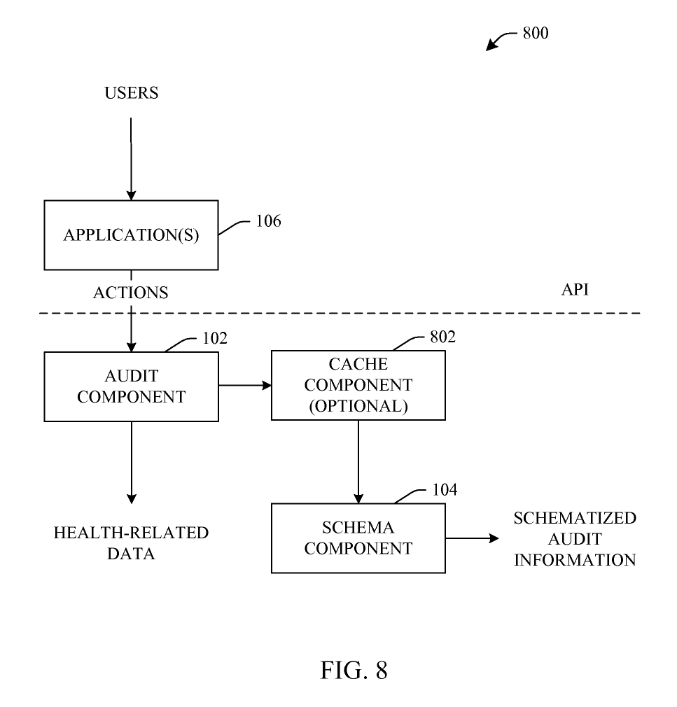

Turning now to FIG. 8, an example block diagram of an alternative system 800 is shown. As illustrated, system 800 employs an optional cache component 802 that facilitates alleviation of storing every action upon detection. While system 800 employs a cache 802 to effect storage alleviation, it is to be understood that most any temporary storage mechanism can be employed without departing from the spirit and/or scope of the innovation. As such, these alternative aspects are to be included within the scope of the innovation and claims appended hereto.

One performance issue of writing to the store (e.g., audit log) on every read of information in the health record can be addressed by creating a cache 802 in the system 800. The cache 802 effectively collates the actions related to the data to improve efficiency in the auditing processes. This collation of actions alleviates the above-mentioned performance issue. It is to be understood that this collation is optional—in other words, the innovation can be performed granularly in other aspects.

In operation, this cache 802 can maintain information about the last known access to the record by the person, application, impersonator, open query, and access avenue combination that was logged in the audit system. Thus, an entry in the audit system representing a read access is not supplemented by another entry representing the same audit combination until it grows old by a configurable amount. Therefore, by increasing the time span that the read access audit represents in the system 800, the innovation can alleviate this issue of writing on every read and continue to fetch health information on demand in a performant fashion.

The innovation can employ machine learning & reasoning (MLR) mechanisms which facilitate automating one or more features in accordance with the subject innovation. The subject innovation (e.g., in connection with selection of an action to audit) can employ various MLR-based schemes for carrying out various aspects thereof. For example, a process for determining which action(s) to audit, what defining information (e.g., parameters) to capture, etc. can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria when to record an action, what information (e.g., parameters) to capture with respect to an action, what schema to select to record audit information, etc.

The innovation can also employ MLR for anomaly detection, for example, if an application or an entity is accessing data that normally the class should not and need not have access to. In a specific example, anomaly detection can refer to a scenario where a weight loss application is attempting to access HIV lab data. Additionally, this detection can also indicate that the user's authorization settings are not set up properly thereby prompting modification.

Still further, it is to be understood that the auditing innovation described here can include a mechanism that can filter the disclosure of particular audit records to the user in compliance with HIPAA (Health Insurance Portability and Accountability Act) as well as other state and federal regulations. Examples of these are when a criminal investigation is in progress and the disclosure of law enforcement's access to a particular user medical record would endanger the case and in some instances, a human life. These and other conceivable embodiments are to be included within the innovation as described and claimed herein.

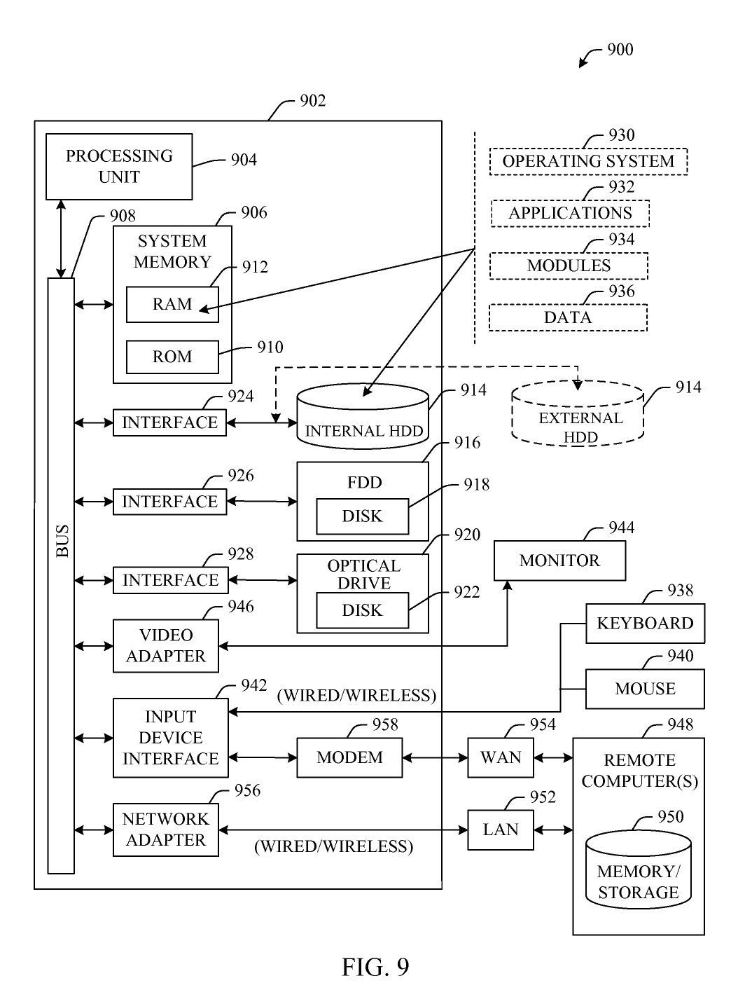

Referring now to FIG. 9, there is illustrated a block diagram of a computer operable to execute the disclosed architecture. In order to provide additional context for various aspects of the subject innovation, FIG. 9 and the following discussion are intended to provide a brief, general description of a suitable computing environment 900 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects of the innovation includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the innovation can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

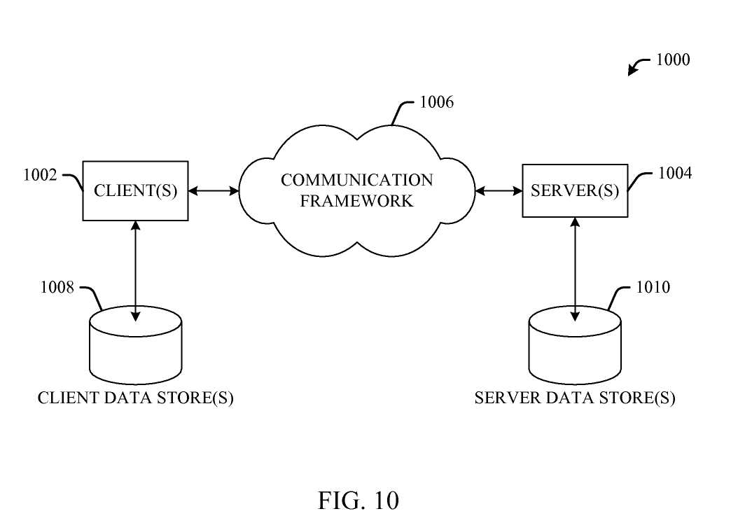

Referring now to FIG. 10, there is illustrated a schematic block diagram of an exemplary computing environment 1000 in accordance with the subject innovation. The system 1000 includes one or more client(s) 1002. The client(s) 1002 can be hardware and/or software (e.g., threads, processes, computing devices). The client(s) 1002 can house cookie(s) and/or associated contextual information by employing the innovation, for example.

The system 1000 also includes one or more server(s) 1004. The server(s) 1004 can also be hardware and/or software (e.g., threads, processes, computing devices). The servers 1004 can house threads to perform transformations by employing the innovation, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates audit of an action associated with a health-related data network, comprising:
an audit component that identifies audit information related to the action; and
a schema component that stores the audit information in an audit log.

2. The system of claim 1, wherein the action is one of a change, modify, create, transfer or delete action associated to a record within the health-related data network.

3. The system of claim 1, wherein the action is an access to a record within the health-related data network.

4. The system of claim 1, wherein the action is a modification in an authorization rule associated with at least one of a grant, revocation or change in authorization of a user or application to a health record within the health-related data network.

5. The system of claim 1, wherein the audit information comprises:
an identity of a data element within the health-related data network;
an identity of a user who prompted the action; and
an identity of an application that presented the action.

6. The system of claim 1, further comprising a monitoring component that continuously tracks a plurality of actions related to one of a data element modification, access or revision to authorization status of a record within the health-related data network, the action is one of the plurality of actions.

7. The system of claim 6, the monitoring component determines a plurality of parameters associated with the action, wherein a subset of the parameters defines the audit information.

8. The system of claim 7, further comprising a capture component that captures the subset of the parameters.

9. The system of claim 1, further comprising a schema component that applies a defined schema template for the audit information.

10. The system of claim 10, wherein the schema component facilitates storage of the audit information.

11. The system of claim 1, further comprising a cache component that regulates storage of the audit information based upon predefined criteria.

12. A method for auditing an action associated with a record within a health-related data network, comprising:
discovering the action;
analyzing the action to determine audit information associated with the action; and
storing the audit information associated with the action into an audit log.

13. The method of claim 12, the audit information includes the record, identity of a user who prompted the action and identity of an application that rendered the action.

14. The method of claim 12, wherein the action is one of an update, change, revision, addition, creation, or deletion of the record.

15. The method of claim 12, wherein the action is an access to the record.

16. The method of claim 15, wherein the action is an authorization modification related to access rights of the record.

17. The method of claim 12, further comprising schematizing the audit information prior to storage within the audit log.

18. The method of claim 12, further comprising caching the audit information until a predetermined event occurs.

19. A computer-executable system of auditing health-related information, comprising:
means for tracking a plurality of actions associated with a plurality of records within a health-related data network, wherein the plurality of actions include modifications, access requests, or authorization changes related to a subset of the records;
means for determining audit information associated with a subset of the actions, wherein the audit information includes a data element associated with the action, identity of a user who triggered the action and identity of an application that conveyed the action; and
means for storing the audit information.

20. The computer-executable system of claim 19, further comprising means for schematizing the audit information prior to storage.
